(19) United States
(12) Patent Application Publication
(10) Pub. No.: US 2026/0165293 A1
(43) Pub. Date: Jun. 18, 2026

(54) ANIMAL FEEDING APPARATUS

(71) Applicant: Phillip Ward Myers, JR., Wayzata, MN (US)

(72) Inventor: Phillip Ward Myers, JR., Wayzata, MN (US)

(21) Appl. No.: 19/377,797

(22) Filed: Nov. 3, 2025

Related U.S. Application Data
(60) Provisional application No. 63/716,080, filed on Nov. 4, 2024.

(51) Int. Cl. A01K 5/01; A01K 13/00

(52) U.S. Cl. CPC A01K 5/0135; A01K 13/003

(57) ABSTRACT

An animal lick pad apparatus comprising a lick pad and a handle. The lick pad can comprise an interaction surface having one or more baffles. The interaction surface can be configured to slowly feed to an animal a substance disposed on the interaction surface. The animal lick pad apparatus can further comprise one or more suction cups on a back side of the lick pad or the handle.

### CROSS-REFERENCE TO RELATED APPLICATIONS

This application claims the benefit of priority to U.S. Provisional Patent Application No. 63/716,080, filed Nov. 4, 2024, the contents of which is incorporated by reference herein in its entirety.

### BACKGROUND

Some people provide food for consumption by animals, such as domesticated animals. Animal food can be provided on a feeding apparatus.

### SUMMARY

Embodiments disclosed herein can relate to an animal feeding apparatus comprising a handle and a textured surface at a distal end of the handle. In some embodiments, the textured surface comprises one or more baffles. In some embodiments, the one or more baffles have a height of at least 5 mm. In some embodiments, the one or more baffles define one or more recesses. In some embodiments, the recesses are sized to hold a spreadable substance. In some embodiments, the animal feeding apparatus further comprises a suction cup. In some such embodiments, the suction cup is disposed on a back side of the interaction surface, and in some such embodiments, the suction cup is disposed on a back side of the handle. In some embodiments, the apparatus comprises silicone. In some embodiments, the handle defines a hole in a proximal end of the handle.

Embodiments disclosed herein relate to a lick pad apparatus comprising a handle and a lick pad connected to the handle, the lick pad comprising a textured surface. In some embodiments, the textured surface comprises one or more baffles. In some embodiments, the one or more baffles define one or more recesses. In some embodiments, the recesses are defined to hold a spreadable substance. In some embodiments, the apparatus further comprises one or more suction cups. In some embodiments, the one or more suctions cups are disposed on a back side of the lick pad. In some embodiments, the one or more suction cups are disposed on a back side of the handle. In some embodiments, the apparatus comprises 12 suction cups. In some embodiments, the apparatus comprises silicone. In some embodiments, the handle defines a hole in an end of the handle opposite the end connected to the lick pad.

### BRIEF DESCRIPTION OF THE DRAWINGS

FIGS. 1A & 1B depict an animal lick pad apparatus in accordance with the embodiments disclosed herein.

FIGS. 2A & 2B depict an animal lick pad apparatus in accordance with the embodiments disclosed herein.

FIG. 3 depicts an animal lick pad apparatus in accordance with the embodiments disclosed herein.

FIG. 4 depicts an animal lick pad apparatus in accordance with the embodiments disclosed herein.

FIG. 5 depicts an animal lick pad apparatus in accordance with the embodiments disclosed herein.

FIG. 6 depicts an animal lick pad apparatus in accordance with the embodiments disclosed herein.

FIG. 7 depicts an animal lick pad apparatus in accordance with the embodiments disclosed herein.

FIG. 8 depicts an animal lick pad apparatus in accordance with the embodiments disclosed herein.

FIG. 9 depicts an animal lick pad apparatus in accordance with the embodiments disclosed herein.

FIG. 10 depicts an animal lick pad apparatus in accordance with the embodiments disclosed herein.

### DESCRIPTION

Animal lick pads can be feeding tools designed to keep animals entertained and mentally stimulated while undertaking another activity. For example, they can keep an animal occupied while a human grooms the animal, bathes the animal, or undertakes another activity from which it is desirable to distract the animal. Embodiments described herein provide for adaptable animal lick pad apparatuses that can be used in different ways. Accordingly, a user can use the animal lick pads of the present disclosure to occupy or otherwise feed an animal in different ways. The animal lick pad apparatuses of the present disclosure can be used in a static manner, such as in a configuration that is temporarily fixed to a surface, or in a free manner, such as held by a user's hand.

The animal lick pad apparatuses disclosed herein can have a lick pad having textured surface with various patterns or grooves on which a user can spread a food product or other substance that is consumable by the animal for which it is being used. For example, a user can spread peanut butter onto the textured surface of the lick pad for consumption by a dog. The animal can then lick or otherwise consume the substance. The textured surfaces can be configured in such a way that the animal is prevented from consuming the substance in a short amount of time, and rather has to slowly consume the substance.

The animal lick pad apparatuses disclosed herein can provide benefits such as distracting an animal, for example, during a procedure. For example, the animal lick pad apparatuses disclosed herein can be used to distract a dog during grooming or a veterinary procedure. The animal lick pad apparatuses disclosed herein can also have a calming effect on an animal. For example, they can calm an animal during a procedure or other situation where an animal experiences anxiety, such as a veterinarian visit, during fireworks, or during a thunderstorm. The animal lick pad apparatuses disclosed herein can also provide mental stimulation for an animal, the benefits of which can include reducing boredom and anxiety. The animal lick pad apparatuses disclosed herein can also benefit the oral health of an animal since the licking action can help clean an animal's teeth, gums, and tongue. Finally, the animal lick pad apparatuses disclosed herein can be used as a slow feeder that prevents an animal from consuming food excessively fast, which can be detrimental to an animal.

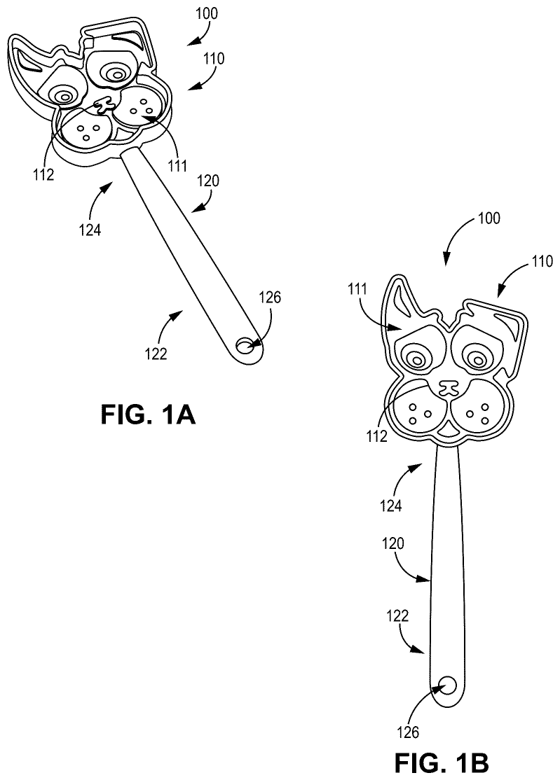

FIGS. 1A & 1B depict an animal lick pad apparatus 100 in accordance with the embodiments disclosed herein. The lick pad apparatus 100 has a handle 120 and a lick pad 110 comprising an interaction surface 111. The lick pad 110 is disposed at a distal end 124 of the handle 120.

The lick pad 110 is the portion of the lick pad apparatus 100 that an animal will lick or otherwise interact with. The interaction surface 111 is a surface of the lick pad 110 on which a substance for animal consumption or use can be disposed. The interaction surface 111 can include baffles 112. The baffles 112 can define grooves, recesses, textures or other portions of the interaction surface 110 on which a substance can be disposed. The baffles 112 can protrude from a base surface of the interaction surface 111 by 1 mm, 2 mm, 3 mm, 4 mm, 5 mm, 6 mm, 7 mm, 8 mm, 9 mm, 10 mm, or greater than 10 mm. The baffles 112 be spaced apart from each other by a distance of 1 mm, 2 mm, 3 mm, 4 mm, 5 mm, 6 mm, 7 mm, 8 mm, 9 mm, 10 mm, or greater than 10 mm. The baffles 112 are configured to slow the consumption of a substance disposed on the interaction surface 111. In this way, the lick pad apparatus 100 can be configured to distract, entertain, or otherwise be used by an animal for a desired period of time, as described above. For example, the interaction surface 111 can be configured with or without baffles 112 such that it takes an animal a desired period of time to consume a substance disposed thereon. As one example, an interaction surface 111 can be configured with baffles that, when peanut butter is spread onto the interaction surface 111, it takes a dog at least 5 minutes to consume the peanut butter disposed thereon. In the exemplary lick pad apparatus 100 depicted by FIGS. 1A & 1B, the interaction surface 111 and corresponding baffles 112 are shaped to look like a dog's face. Any other shape is possible consistent with the embodiments disclosed herein.

The lick pad apparatus 100 can have one or more suction cups. One or more suction cups can be disposed on a back side of the handle 120 or on a back side of the interaction surface 110. The lick pad can include 1, 2, 3, 4, 5, 6, 7, 8, 9, 10, 11, 12, 13, 14, 15, or greater than 15 suction cups. The one or more suction cups can be used to fix the lick pad apparatus 100 in a position for use and/or storage. For example, the lick pad apparatus 100 can be fixed to a surface of a tub or sink while an animal is being bathed. The animal can then be distracted by the lick pad apparatus 100 while a person bathes the animal.

Although in some use cases, the lick pad apparatus 100 can be fixed to a surface using one or more suction cups while in use, in some use cases the lick pad apparatus 100 can be held in a user's hand while in use. Thus, the lick pad apparatus 100 is adaptable and can be used in any scenario where it is advantageous or desirable to be fixed in place while in use and in any scenario where it is advantageous or desirable to be held in a user's hand while in use. In some use cases, both handheld and static use can be used. For example, a user can hold a lick pad apparatus 100 in their hand while guiding an animal from one location to another, and then the user can fix the lick pad apparatus 100 in the final location using one or more suction cups.

The lick pad apparatus 100 can have a hole 126 in a proximal end 122 of the handle 120. The hole 126 can be used to hang or secure the lick pad apparatus 100. For example, the hole 126 can receive a hook so that the lick pad apparatus 100 can be hung from the hook. The hole 126 can also receive a loop that can be hung on a hook, a carabiner, or any other structure for securing and/or hanging the lick pad apparatus 100.

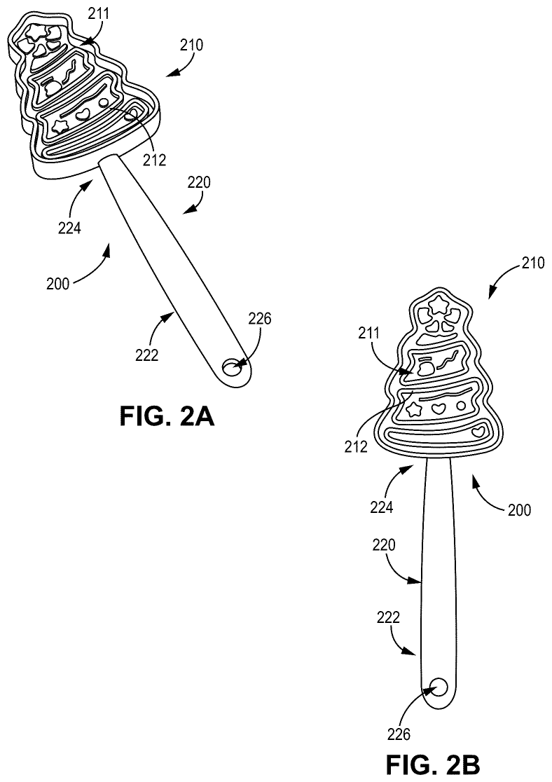

FIGS. 2A & 2B depict an animal lick pad apparatus 200 in accordance with the embodiments disclosed herein. The animal lick pad apparatus 200 has a lick pad 210 comprising an interaction surface 211 with baffles 212 disposed on a distal end 224 of a handle 220. The handle 220 can have a hole 226 in a proximal end 222. The animal lick pad apparatus 200 has a lick pad 210 configured in the shape of a Christmas tree, but it is otherwise consistent with the lick pad apparatus 100 described above with reference to FIGS. 1A & 1B.

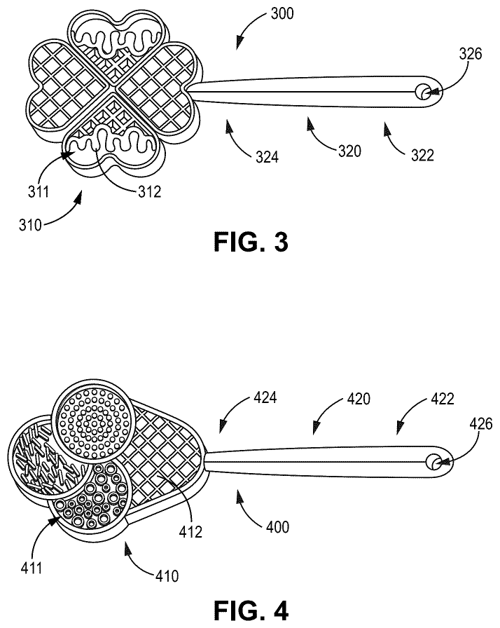

FIG. 3 depicts an animal lick pad apparatus 300 in accordance with the embodiments disclosed herein. The animal lick pad apparatus 300 has a lick pad 310 comprising an interaction surface 311 with baffles 312 disposed on a distal end 324 of a handle 320. The handle 320 can have a hole 326 in a proximal end 322. The animal lick pad apparatus 300 has a lick pad 310 configured in the shape of a waffle, but it is otherwise consistent with the lick pad apparatus 100 described above with reference to FIGS. 1A & 1B.

FIG. 4 depicts an animal lick pad apparatus 400 in accordance with the embodiments disclosed herein. The animal lick pad apparatus 400 has a lick pad 410 comprising an interaction surface 411 with baffles 412 disposed on a distal end 424 of a handle 420. The handle 420 can have a hole 426 in a proximal end 422. The animal lick pad apparatus 400 has a lick pad 410 configured in the shape of an ice cream cone, but it is otherwise consistent with the lick pad apparatus 100 described above with reference to FIGS. 1A & 1B.

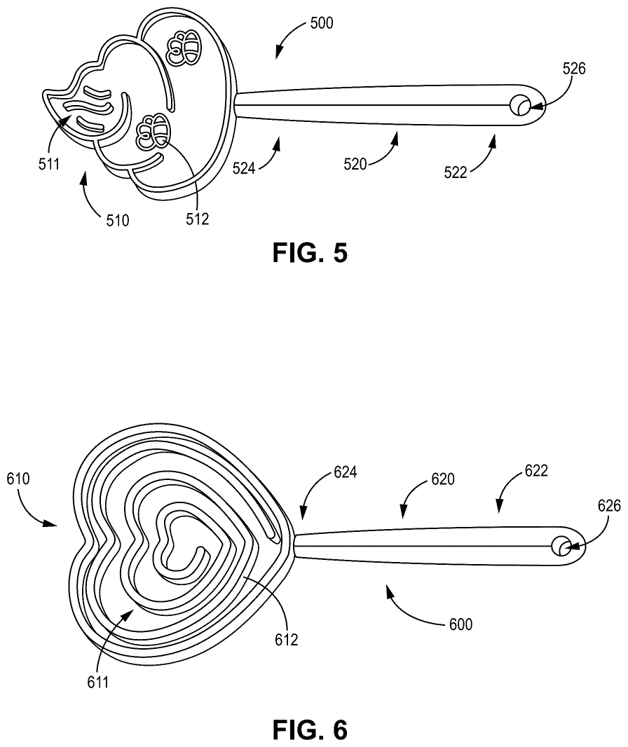

FIG. 5 depicts an animal lick pad apparatus 500 in accordance with the embodiments disclosed herein. The animal lick pad apparatus 500 has a lick pad 510 comprising an interaction surface 511 with baffles 512 disposed on a distal end 524 of a handle 520. The handle 520 can have a hole 526 in a proximal end 522. The animal lick pad apparatus 500 has a lick pad 510 configured in the shape of animal scat (e.g., a poop emoji), but it is otherwise consistent with the lick pad apparatus 100 described above with reference to FIGS. 1A & 1B.

FIG. 6 depicts an animal lick pad apparatus 600 in accordance with the embodiments disclosed herein. The animal lick pad apparatus 600 has a lick pad 610 comprising an interaction surface 611 with baffles 612 disposed on a distal end 624 of a handle 620. The handle 620 can have a hole 626 in a proximal end 622. The animal lick pad apparatus 600 has a lick pad 610 configured in the shape of a heart, but it is otherwise consistent with the lick pad apparatus 100 described above with reference to FIGS. 1A & 1B.

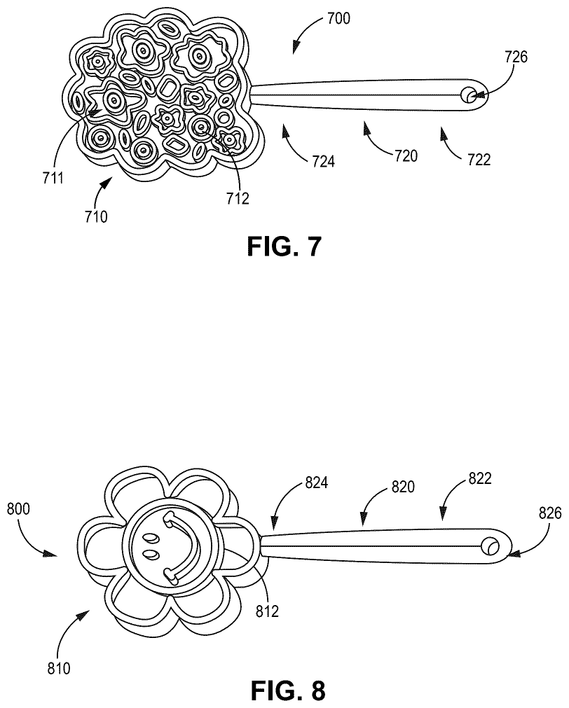

FIG. 7 depicts an animal lick pad apparatus 700 in accordance with the embodiments disclosed herein. The animal lick pad apparatus 700 has a lick pad 710 comprising an interaction surface 711 with baffles 712 disposed on a distal end 724 of a handle 720. The handle 720 can have a hole 726 in a proximal end 722. The animal lick pad apparatus 700 has a lick pad 710 configured in the shape of a tree, but it is otherwise consistent with the lick pad apparatus 100 described above with reference to FIGS. 1A & 1B.

FIG. 8 depicts an animal lick pad apparatus 800 in accordance with the embodiments disclosed herein. The animal lick pad apparatus 800 has a lick pad 810 comprising an interaction surface 811 with baffles 812 disposed on a distal end 824 of a handle 820. The handle 820 can have a hole 826 in a proximal end 822. The animal lick pad apparatus 800 has a lick pad 810 configured in the shape of a flower, but it is otherwise consistent with the lick pad apparatus 100 described above with reference to FIGS. 1A & 1B.

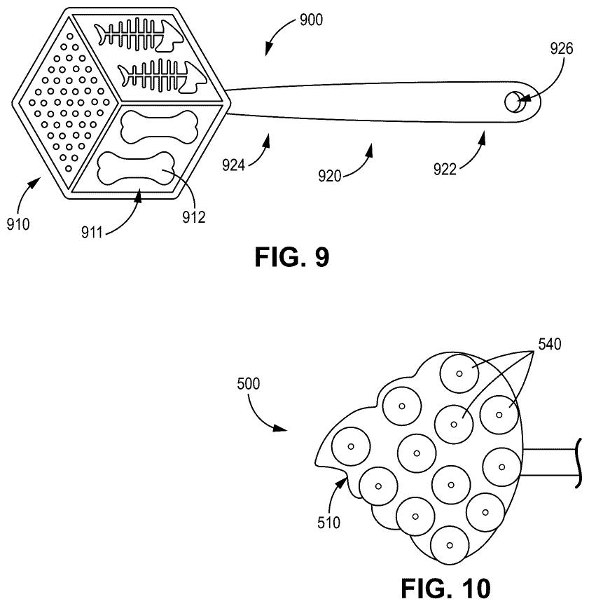

FIG. 9 depicts an animal lick pad apparatus 900 in accordance with the embodiments disclosed herein. The animal lick pad apparatus 900 has a lick pad 910 comprising an interaction surface 911 with baffles 912 disposed on a distal end 924 of a handle 920. The handle 920 can have a hole 926 in a proximal end 922. The animal lick pad apparatus 900 has a lick pad 910 configured in the shape of a hexagon appearing as a perspective view of a cube, but it is otherwise consistent with the lick pad apparatus 100 described above with reference to FIGS. 1A & 1B.

FIG. 10 depicts a view of the back side of the lick pad 510 of the lick pad apparatus 500. The lick pad apparatus 500 has a plurality of suction cups 540 on the back of the lick pad 510. The suction cups 540 are consistent with the various suction cups described herein.

The animal feeding apparatuses disclosed herein can be used with various substances. For example, the animal feeding apparatuses can be used with consumable substances including but not limited to peanut butter, yogurt, cat food, dog food, spreadable meat, or any other substance for consumption by an animal. The feeding apparatus can also be used with a spreadable medication, oral health product such as toothpaste, or any other substance for use with an animal.

The materials used to construct the components of the lick pad apparatuses disclosed herein are not limited. In some embodiments, the animal feeding apparatus is made of silicone, such as food grade and dishwasher-safe silicone. Other exemplary materials can include any silicone material, rubber material, plastic material, or any other material that is safe for an animal to consume a substance from. Other materials such as metals can be used.

What is claimed:

1. An animal feeding apparatus comprising:
a handle; and
a textured surface at a distal end of the handle.

2. The apparatus of claim 1, wherein the textured surface comprises one or more baffles.

3. The apparatus of claim 1, wherein the one or more baffles have a height of at least 5 mm.

4. The apparatus of claim 11, wherein one or more baffles define one or more recesses.

5. The apparatus of claim 12, wherein the recesses are sized to hold a spreadable substance.

6. The apparatus of claim 1, further comprising a suction cup.

7. The apparatus of claim 6, wherein the suction cup is disposed on a back side of the interaction surface.

8. The apparatus of claim 6, wherein the suction cup is disposed on a back side of the handle.

9. The apparatus of claim 1, wherein the apparatus comprises silicone.

10. The apparatus of claim 1, wherein the handle defines a hole in a proximal end of the handle.

11. A lick pad apparatus comprising:
a handle; and
a lick pad connected to the handle, the lick pad comprising a textured surface.

12. The apparatus of claim 11, wherein the textured surface comprises one or more baffles.

13. The apparatus of claim 12, wherein the one or more baffles define one or more recesses.

14. The apparatus of claim 13, wherein the recesses are sized to hold a spreadable substance.

15. The apparatus of claim 11, further comprising one or more suction cups.

16. The apparatus of claim 15, wherein the one or more suctions cups are disposed on a back side of the lick pad.

17. The apparatus of claim 15, wherein the one or more suction cups are disposed on a back side of the handle.

18. The apparatus of claim 15, wherein the apparatus comprises 12 suction cups.

19. The apparatus of claim 11, wherein the apparatus comprises silicone.

20. The apparatus of claim 11, wherein the handle defines a hole in an end of the handle opposite the end connected to the lick pad.
